(19) United States
(12) Patent Application Publication
(10) Pub. No.: US 2018/0114183 A1
(43) Pub. Date: Apr. 26, 2018

(54) Stock Level Determination

(71) Applicant: Wal-Mart Stores, Inc., Bentonville, AR (US)

(72) Inventor: Daniel B. Howell, Bentonville, AR (US)

(21) Appl. No.: 15/726,985

(22) Filed: Oct. 6, 2017

Related U.S. Application Data
(60) Provisional application No. 62/412,342, filed on Oct. 25, 2016.

(51) Int. Cl. G06Q 10/08; G02B 5/10; G06K 9/00; G06K 9/20

(52) U.S. Cl. CPC G06Q 10/087; G02B 5/10; G06K 9/2036; G06K 9/00771; G06K 9/00664

(57) ABSTRACT

In some embodiments, apparatuses and methods are provided herein useful to determine a stock level for products on a product display using a mirror to provide a view of the product display and/or products stocked thereon. The mirror can have a convex or segmented convex configuration to provide a wider field-of-view than a flat mirror. Further, the system described herein can include an electronic imager or machine readable code scanner that utilizes the mirror to capture an image of the product display and products stocked thereon or to scan machine readable codes on the product display or products. The image or scan can then be sent to a control circuit for analysis and stock level determination. The control circuit can also create workflow tasks to check the product display, restock, order more inventory, and the like.

### CROSS-REFERENCE TO RELATED APPLICATION

This application claims the benefit of the following U.S. Provisional Application No. 62/412,342 filed Oct. 25, 2016, which is incorporated herein by reference in its entirety.

### TECHNICAL FIELD

This invention relates generally to retail shelving and, more particularly, to stock level tracking of products for retail merchandising units.

### BACKGROUND

Retail stores often utilize modular shelving units to display products for sale. It can be important to maintain an accurate count of inventory during operation of the store. Pursuant to this, associates have to count products on the shelves. It can be difficult for associates to accurately determine a count of products on the shelves and, as such, one method to ensure an accurate count to remove all of the products from the shelves. Accordingly, the associates must then restock the products on the shelves. Prior attempts at automating the tracking of stock levels indirectly have been difficult to implement due to prohibitive costs and technical limitations.

### BRIEF DESCRIPTION OF THE DRAWINGS

Disclosed herein are embodiments of systems, apparatuses and methods pertaining to determining a stock level of products on a product display and creating workflow tasks in response to detecting a low stock level. This description includes drawings, wherein:

FIG. 1 is a perspective view of an example merchandising unit in accordance with some embodiments.

FIG. 2 is a diagrammatic side elevational view of a stock level detection system showing a convex mirror and a camera device in accordance with several embodiments.

FIG. 3 is a diagrammatic side elevational view of a stock level detection system showing a segmented, stepped mirror and a scanner device in accordance with some embodiments.

FIG. 4 is a flowchart in accordance with several embodiments.

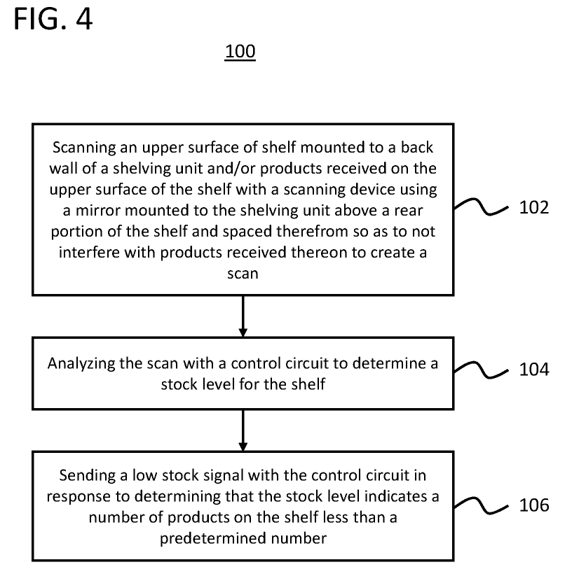

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to determine a stock level for products on a product display, such as a shelf of a shelving unit or other merchandizing fixtures, such as shelf pegs, hook racks, and so forth. A mirror provides a view of the product display and/or products stocked thereon to thereby determine a stock level for the product or how many products on are the display. Advantageously, the mirror can have a convex configuration or a segmented convex configuration to provide a wider field-of-view than a flat mirror. Further, the system described herein can include an electronic imager or machine readable code scanner that utilizes the mirror to capture an image of the product display and products stocked thereon or to scan machine readable codes on the product display or products. The image or scan can then be sent to a control circuit for analysis and stock level determination. The control circuit can also create workflow tasks to check the product display, restock, order more inventory, and the like. So configured, the system described herein can monitor the stock level on one or more product displays and automatically provide a notification for low stock levels.

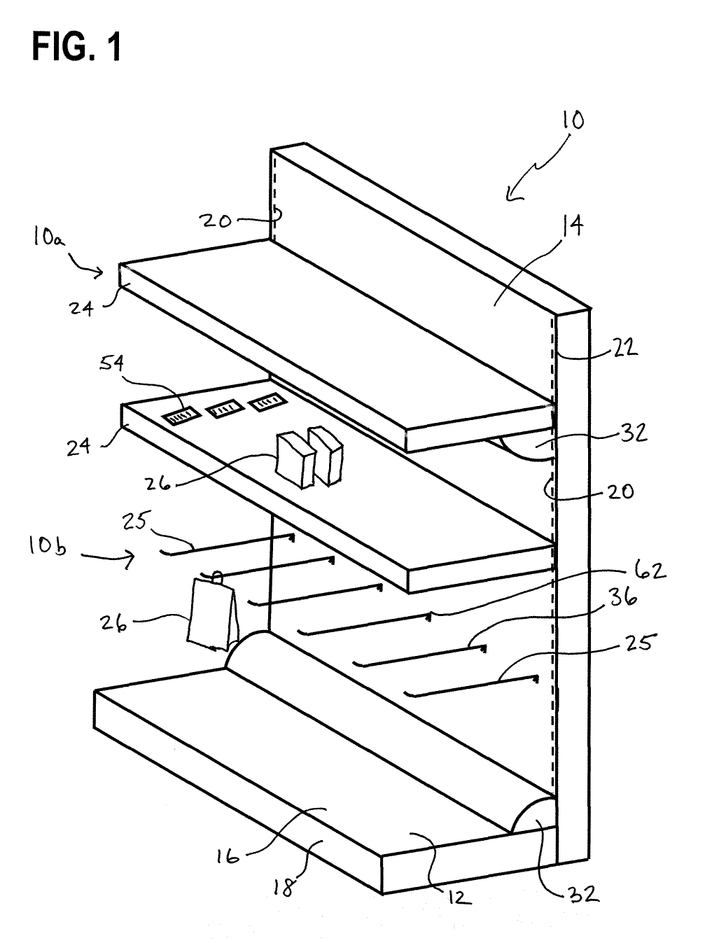

An example merchandising unit 10 is shown in FIG. 1. Based on a particular use, multiple merchandizing units 10 can be aligned in a row to produce an aisle in a retail location. The merchandizing unit 10 includes a base portion 12 and a back wall 14 extending upwardly therefrom. The base portion 12 can include a base deck 16 and a kick plate 18, as commonly configured. The merchandising unit 10 can further include one or more product support members mounted thereto, such as shelves 24 or rows of pegs or hooks 25. In one form, as shown on a top portion 10a of the merchandizing unit 10, the merchandizing unit can be a shelving unit including a plurality of shelf notches 20 vertically disposed adjacent to lateral edges 22 of the back wall 14 to provide anchor points for the shelves 24 mounted thereto. Of course, the shelves 24 can be mounted to the back wall 14 in any suitable way, including using fasteners, snap-fit structure, friction fitting, or the like. Additionally, although the product support member is described herein with reference to a shelf on a shelving unit, any suitable form, location, and/or mounting location can be utilized. For example, the product support member can be a table, a shelf mounted to a wall, or the like. In another form, as shown on a bottom portion 10b of the merchandizing unit 10, the pegs or hooks 25 can be mounted to the back wall 14 thereof, such as in a plurality of rows. After the merchandizing unit 10 is assembled, associates can then stock products 26 on the shelves 24 or pegs 25.

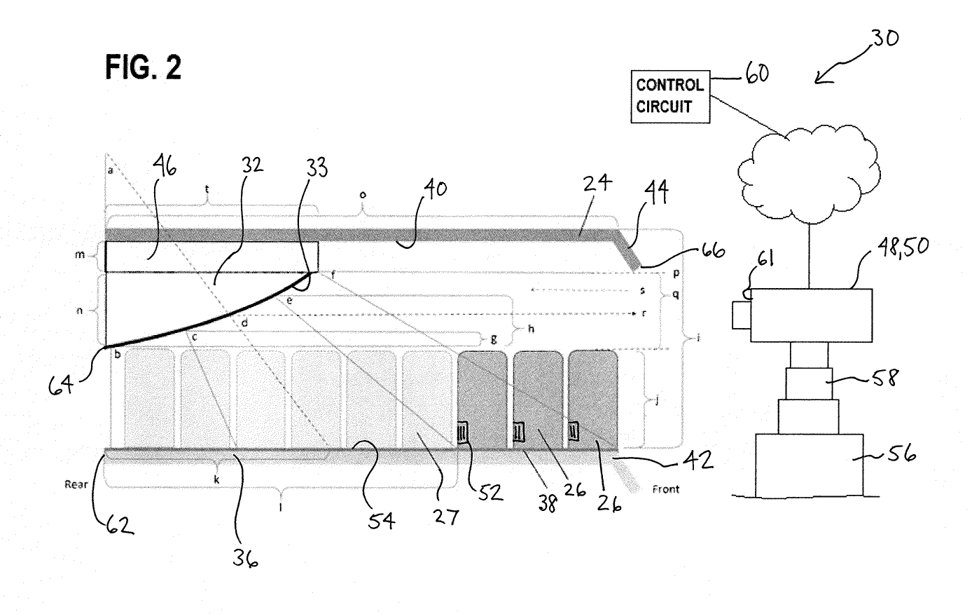

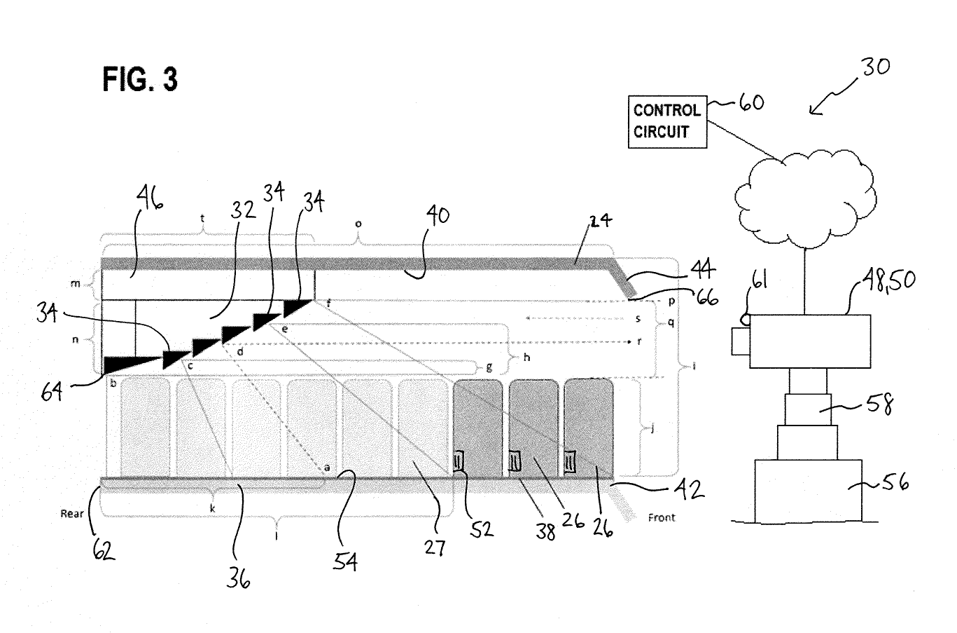

A stock level indication system 30 is shown in FIGS. 1-3. The system 30 includes a mirror 32 mounted to the merchandizing unit 10 above one of the shelves 24 and oriented to provide a view of the shelf 24 and any products 26 stocked thereon from a vantage point, such as generally horizontally in front of the merchandizing unit 10. In some embodiments, the mirror 32 can be configured to provide an expanded field-of-view. In a first approach as shown in FIG. 2, a surface 33 of the mirror 32 can have a convexly curved configuration. In a second approach as shown in FIG. 3, the mirror 32 can be composed of a plurality of segments 34 that are arranged in a stepped configured to approximate a curved surface. For example, as shown, adjacent segments 34 can be mounted offset from one another to produce a mirror 32 having a field-of-view similar to that of a convex mirror using the planar segments 34. In either instance, the mirror 32 can be geometrically optimized according to specific dimensions and configurations to provide a view of the shelf 32.

In shelving unit embodiments, the mirror 32 is preferably mounted above a rear portion 36 of the shelf 24, and preferably extending to a rear edge 62 thereof, so that, from a position in front of the merchandising unit 10, a majority of an upper surface 38 of the shelf 24 can be viewed through the mirror 32 from one viewing position. Further, positioning the mirror 32 above the rear portion 36 of the shelf 24 provides a view thereof that may be blocked by facing products 26. In peg or hook embodiments, the mirror 32 is preferably mounted below the rear portion 36 of the peg 25, and preferably extending to the rear edge 62 thereof, to provide a view of the products 26 hanging from an outer surface 39 of the peg 25. Alternatively, the mirror 32 can be mounted above the pegs 25 and below the hanging products 26 from above pegs 25. In this alternative form, the orientations and references would be similar to the shelving unit embodiments.

The mirror 32 can be mounted to the merchandizing unit 10 in a variety of suitable configurations to provide satisfactory views. For example, the mirror 32 can be mounted to the back wall 14 and/or a bottom surface 40 of the shelf 24 or other structure disposed above the shelf 24. In some embodiments, a front 42 of the shelf 24 or peg 25 can include a hanging tag, edge, or other display 44 that could obscure a view of the mirror 32. Accordingly, in some embodiments, the mirror 32 can be spaced from the shelf bottom surface 40 or can include a spacer member or portion 46 so that the mirror 32 is visible beneath the tag 44 from in front of the merchandizing unit 10.

Advantageously, by one approach, the system 30 can include an electronic imager 48, such as a camera, to capture images of a reflection of the shelf 24 or peg 25 using the mirror 32 showing products 26 stocked thereon as well as any empty space. By another approach, the system 30 can include a scanner 50 configured to read machine-readable codes. So configured, the scanner 50 can be utilized to scan machine-readable codes using the mirror 32. In a first form, the scanner 50 can be configured to scan barcodes 52 or other machine-readable codes disposed on or in the packaging of the products 26. As such, the number of barcodes 52 scanned will provide an indication of stock level. In a second form, the shelf upper surface 38 can have symbologies or other machine readable codes 54 disposed thereon. As such, when products 26 are stocked on the shelf 24, the products 26 will block the symbologies 54 from view of the scanner 50. A number or size of scanned symbologies 54 can provide an indication of a stock level on the shelf 24. The electronic imager 48 and/or scanner 50 can be utilized to provide line-of-sight examination of the shelf 24 or peg 25 and the stock level thereof using the mirror 32.

In some embodiments, the camera 48 and/or scanner 50 can be carried by an associate, such as using auto-stabilizing mechanisms. So configured, the associate can carry the camera 48 and/or scanner 50 horizontally past the merchandising units 10 and each of the shelves 24 or rows of pegs 25 thereof. The associate can further vertically move the camera 48 and/or scanner 50 along the merchandising unit 10 so that each shelf 24 or row or pegs 25 can be analyzed.

In further embodiments, the camera 48 and/or scanner 50 can be mounted to a movable structure 56, such as a cart or the like, so that it can move down an aisle to photograph or scan shelves 24 or pegs 25 on a plurality of merchandizing units 10. By one approach, the camera 48 or scanner can have a set height so that the camera/scanner 48, 50 provides an indication of stock level from one perspective/height from in front of the merchandizing unit 10. Further, the cart 56 can be continuously moved horizontally past the merchandizing unit 10 or can be stopped in front thereof for the camera 48 and/or scanner 50 to operate. By another approach, the camera and/or scanner 50 can have an adjustable height so that it can be aligned with the mirrors 32 of multiple shelves 24 or pegs 25 on a merchandizing unit 10. For example, the camera 48 and/or scanner 50 can be mounted to a telescoping structure 58. If desired, to provide a dynamic view of the shelf 24, the camera/scanner 48, 50 can be configured to continuously or periodically operate as it is moved upwardly or downwardly to provide multiple perspectives of the shelf 24 or pegs 25 through the mirror 32 and thereby provide a more comprehensive view of the shelf 24 or pegs 25. For example, the camera/scanner 48, 50 can operate in response to determining that the mirror 32 or a machine readable code 52, 54 is in view, according to modular and stocking information for the shelving unit, and so forth. As such, the camera/scanner 48, 50 can have onboard circuitry to determine its location and height, such as by telemetry, gps, Wi-Fi triangulation, a range finder, capture location data, and so forth.

By one approach, the cart 56 can be manually moved down an aisle by an associate. By another approach, the cart 56 can be a robot or drone configured to receive command signals and follow predetermined paths through a retail location. Moreover, the height of the camera 48 and/or scanner 50 can be manually adjusted, such as with the help of mirror height indicators, or can be automatically adjusted with a control circuit operating a motor or the like according to modular and product data for a retail location.

Next, the image and/or scan can be sent to a control circuit 60 for analysis. The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 60 may be configured (for example, by using corresponding programming stored in a memory as will be well understood by those skilled in the art) to carry out one or more of the steps, actions, and/or functions described herein.

In embodiments utilizing the camera 48, the control circuit 60 can be configured with image analysis software as commonly understood to determine a stock level of products 26 on the shelf 24 or pegs 25. As set forth above, the analysis can be directed to determine an amount of empty shelf space and/or determining a number of visible products 26 stocked on the shelf 24 or pegs 25. Due to the enhanced field-of-view provided by the mirror 32, the image may be distorted. Accordingly, the control circuit 60 can utilize algorithms as commonly understood to deconstruct the distorted image and further algorithms to produce an accurate count of the products 26 and/or an accurate determination of empty shelf space from the deconstructed image. By one approach, the control circuit 60 can receive or retrieve modular information for the merchandising unit 10 and product information for the products 26 stocked on the shelf 24 or pegs 25 to aid in the determination. The modular and product information can include shelf/peg dimensions, product dimensions, a number of products in a fully stocked configuration, a number of products corresponding to a low stock configuration, and the like.

If desired, the system 30 can include a light source 61 oriented to project light into the mirror to thereby provide an illuminated view of the shelf 24 or pegs 25 for the camera 48 or scanner 50. The light source 61 can be mounted or coupled to the camera 48 or scanner 50 or can be separate therefrom, such as mounted to the merchandising unit 10 or the cart 56. In a preferred form, the light source 61 can be oriented in a generally parallel direction to the camera 48 or scanner 50 orientation and the shelf upper surface 38 or pegs 25.

The various characteristics of the exemplary systems 30 will now be described with reference to FIGS. 2 and 3. Although embodiments utilizing a shelf 24 are described and shown, peg or hook merchandising units 10 can include similar references, albeit from a flipped perspective. Reference “a” refers to the focal point for the mirror 32, which is behind the mirror 32 due to the curved configuration thereof. The focal point is the optimal point for a view of the shelf upper surface 38. Reference “b” refers to an angle of reflection for the most oblique perspective that allows for a rear 48 of shelf to be visible through the mirror 32 from a perspective parallel to a vector “r.” Reference “c” refers to a vertically shiftable angle of reflection where the upper surface 38 of the shelf 24 is visible through the mirror 32 via a perspective parallel to the vector “r.” Reference “d” refers to the normal line of the mirror 32 or the angle of reflection that is aligned with the focal point “a” of the mirror 32 that maximizes the view of the shelf 24. Reference “e” refers to an example angle of reflection that can be used to indicate a low stock level for the shelf 24. Accordingly, if the analysis of the control circuit 60 determines that there are no products 26 from a rear edge 62 of the shelf 24 up until this angle, the system 30 may initiate an action or report about the data collected. Reference “f” refers to an example angle of reflection that represents the most acute angle for a camera/scanner perspective to have a clear view of the shelf 24 and any products 26 stocked thereon. Stated another way, the example angle “f” can correspond to a maximum viewable surface of the shelf 24 and any products 26 stocked thereon. FIGS. 2 and 3 include grayed-out areas 27 corresponding to areas for products that are currently out of stock.

Reference “g” refers to a vertical distance between a lowermost, rear point 64 of the mirror 32 and a point on the mirror corresponding to the angle “c.” This distance “g” may be used to calculate, in part, the sell through of products 26 on the shelf 24 and can be used in the algorithm. Reference “h” refers to a vertical distance the lowermost, rear point 64 of the mirror 32 and a point on the mirror 32 corresponding to the angle “e” representing the recognition of a low stock level that would initiate some action by the inventory system. Reference “i” refers to a vertical distance between the shelf upper surface 38 and an upper surface 38 of the shelf 24 above. This vertical height “i” is a variable usually dependent on the height of the products 26 stocked on the shelf 24 with any necessary headroom for handling of the products 26. Reference “j” refers to the height of the products 26. Reference “k” refers to the distance between the rear edge 62 of the shelf 24 and a point on the shelf 24 aligned with the normal line “a” of the mirror 32. This distance “k” may correspond or be proportionate to the maximum possible viewable portion of the shelf upper surface 38. The distance may also be associated with a low stock level and creation of a corresponding low stock signal. Reference “l” refers to a distance between the rear edge 62 of the shelf 24 and a point on the shelf 24 that represents a desired low stock product amount. This distance “l” can be equal to distance “k,” can correspond to product dimensions, a distance representative of the action needed, a distance proportionate to the maximum possible viewable surface of the shelf 24 or products 26, and so forth.

Reference “m” refers to a distance that the downwardly hanging tag 44 extends and a corresponding height of the spacer member 46. Reference “n” refers to a vertical height of the mirror 32. The vertical height “n” may be constrained by the shelf available height “i,” the height of the product “j,” the overhang “m” of the tag 44, and any additional space needed for proper reflection angles. Reference “o” refers to a depth of the shelf 32, which can influence or determine the maximum viewable upper surface 38 that the mirror 32 can to reflect out into the camera 48 or scanner 50.

Reference “p” refers to a horizontal height corresponding to a lower edge 66 of the tag 44 and reference “q” refers to a vertical space between the top of the products 26 and the lower edge 66 of the tag 44 for viewing by the camera 48 and scanner 50. Reference “r” refers to an optimum vector and angle for the camera 48 or scanner 50 to view a reflection of the shelf 32 and any products 26 stocked thereon. Viewing from perspectives above or below of the vector “r” also functions, but provides a smaller and/or more distorted view of the shelf 24. Reference “s” refers to a vector at a height and angle for providing external lighting to shine on the mirror 32 to illuminate the shelf 24 and products 26 stocked thereon for viewing by the camera 48 or scanner 50. Reference “t” refers to a depth of the mirror 32 that provides a normal angle to a desired maximum viewable surface of the shelf 24 and products 26.

In some embodiments, a stock level indication apparatus is described herein that includes a merchandising unit including a back wall and a product support member mounted to the back wall. The product support member has a surface configured to receive products thereon extending between a front edge and a back edge thereof. The stock level indication apparatus further includes a mirror mounted to the merchandising unit adjacent to a rear portion of the product support member and spaced therefrom so as to not interfere with products received thereon. The mirror is oriented to provide a view of the surface of the product support member and products received thereon from a position adjacent to the front edge of the product support member. The stock level indication apparatus further includes a scanning device disposed adjacent to the front edge of the product support member and configured to scan the product support member and/or the products received thereon using the mirror and a control circuit in communication with the scanning device and configured to analyze the scan of the product support member and/or the products to determine a stock level for the product support member.

By several approaches, the product support member can be a shelf, the merchandising unit can include a plurality of shelves; and the mirror can be mounted to the back wall of the merchandising unit and spaced from a bottom surface of an above shelf of the plurality of shelves. By other approaches, the mirror can be mounted to a bottom surface of one of the plurality of shelves.

By some approaches, the mirror is a convex mirror. By further approaches, the mirror is a convexly segmented mirror.

By several approaches, the scanning device is a mobile electronic imager. By further approaches, the scanning device is a barcode reader.

By some approaches, the control circuit can be configured to send a low stock signal in response to determining that the stock level indicates a number of products on the product support member is less than a predetermined number.

By several approaches, the control circuit can be configured to analyze the scan for empty space on the product support member to determine the stock level. By further approaches, the control circuit can be configured to analyze the scan to count products received on the product support member to determine the stock level.

In several embodiments, a method for providing an indication of stock level is described herein that includes scanning a surface of a product support member mounted to a back wall of a merchandising unit and/or products received on the surface of the product support member with a scanning device using a mirror mounted to the merchandising unit adjacent to a rear portion of the product support member and spaced therefrom so as to not interfere with products received thereon to create a scan, the mirror oriented to provide a view of the surface of the product support member and products received thereon from a position adjacent to the front edge of the product support member; and analyzing the scan with a control circuit to determine a stock level for the product support member.

By some approaches, the mirror comprises a convex mirror such that the scan shows a distorted view, and analyzing the scan comprises undistorting the scan.

By several approaches, scanning the surface of the product support member comprises moving the scanning device along a vertical axis to obtain scans from a plurality of heights. By some approaches, scanning the surface of the product support member comprises moving the scanning device along a horizontal plane to obtain scans from a plurality of different positions.

By some approaches, the scanning device can be a mobile electronic imager, and scanning the surface of the product support member comprises capturing an image of the surface of the product support member. By further approaches, the scanning device can be a barcode reader, and scanning the surface of the product support member comprises scanning barcodes of products received on the surface of the product support member.

By several approaches, analyzing the scan with the control circuit comprises analyzing the scan for empty space on the product support member to determine the stock level. By some approaches, analyzing the scan with the control circuit comprises analyzing the scan to count products received on the product support member to determine the stock level.

By some approaches, the method can further include sending a low stock signal with the control circuit in response to determining that the stock level indicates a number of products on the product support member is less than a predetermined number.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A stock level indication apparatus comprising:
a merchandising unit including a back wall and a product support member mounted to the back wall, the product support member having a surface configured to receive products thereon extending between a front edge and a back edge thereof;
a mirror mounted to the merchandising unit adjacent to a rear portion of the product support member and spaced therefrom so as to not interfere with products received thereon, the mirror oriented to provide a view of the surface of the product support member and products received thereon from a position adjacent to the front edge of the product support member;
a scanning device disposed adjacent to the front edge of the product support member and configured to scan the product support member and/or the products received thereon using the mirror;
a control circuit in communication with the scanning device and configured to analyze the scan of the product support member and/or the products to determine a stock level for the product support member.

2. The stock level indication apparatus of claim 1, wherein the mirror comprises a convex mirror.

3. The stock level indication apparatus of claim 1, wherein the mirror comprises a convexly segmented mirror.

4. The stock level indication apparatus of claim 1, wherein the product support member comprises a shelf, the merchandising unit includes a plurality of shelves; and the mirror is mounted to the back wall of the merchandising unit and spaced from a bottom surface of an above shelf of the plurality of shelves.

5. The stock level indication apparatus of claim 1, wherein the product support member comprises a shelf, the merchandising unit includes a plurality of shelves; and the mirror is mounted to a bottom surface of one of the plurality of shelves.

6. The stock level indication apparatus of claim 1, wherein the scanning device comprises a mobile electronic imager.

7. The stock level indication apparatus of claim 1, wherein the scanning device comprises a barcode reader.

8. The stock level indication apparatus of claim 1, wherein the scanning device is configured to scan the product support member and/or the products received thereon using the mirror from a plurality of heights.

9. The stock level indication apparatus of claim 1, wherein the scanning device is configured to scan the product support member and/or the products received thereon using the mirror from a plurality of different horizontal positions.

10. The stock level indication apparatus of claim 1, wherein the control circuit is configured to send a low stock signal in response to determining that the stock level indicates a number of products on the product support member is less than a predetermined number.

11. The stock level indication apparatus of claim 1, wherein the control circuit is configured to analyze the scan for empty space on the product support member to determine the stock level.

12. The stock level indication apparatus of claim 1, wherein the control circuit is configured to analyze the scan to count products received on the product support member to determine the stock level.

13. A method for providing an indication of stock level, the method comprising:
scanning a surface of a product support member mounted to a back wall of a merchandising unit and/or products received on the surface of the product support member with a scanning device using a mirror mounted to the merchandising unit adjacent to a rear portion of the product support member and spaced therefrom so as to not interfere with products received thereon to create a scan, the mirror oriented to provide a view of the surface of the product support member and products received thereon from a position adjacent to the front edge of the product support member;
analyzing the scan with a control circuit to determine a stock level for the product support member.

14. The method of claim 13, wherein the mirror comprises a convex mirror such that the scan shows a distorted view, and analyzing the scan comprises undistorting the scan.

15. The method of claim 13, wherein the mirror comprises a convexly segmented mirror.

16. The method of claim 13, wherein scanning the surface of the product support member comprises moving the scanning device along a vertical axis to obtain scans from a plurality of heights.

17. The method of claim 13, wherein scanning the surface of the product support member comprises moving the scanning device along a horizontal plane to obtain scans from a plurality of different positions.

18. The method of claim 13, wherein the scanning device comprises a mobile electronic imager, and scanning the surface of the product support member comprises capturing an image of the surface of the product support member.

19. The method of claim 13, wherein the scanning device comprises a barcode reader, and scanning the surface of the product support member comprises scanning barcodes of products received on the surface of the product support member.

20. The method of claim 13, wherein analyzing the scan with the control circuit comprises analyzing the scan for empty space on the product support member to determine the stock level.

21. The method of claim 13, wherein analyzing the scan with the control circuit comprises analyzing the scan to count products received on the product support member to determine the stock level.

22. The method of claim 13, further comprising sending a low stock signal with the control circuit in response to determining that the stock level indicates a number of products on the product support member is less than a predetermined number.
